(19) United States
(12) Patent Application Publication
(10) Pub. No.: US 2019/0272765 A1
(43) Pub. Date: Sep. 5, 2019

(54) Online Teaching System and Method thereof

(71) Applicants: Tu Song-Anh Nguyen, Irvine, CA (US); Charles Nguyen, Irvine, CA (US)

(72) Inventors: Tu Song-Anh Nguyen, Irvine, CA (US); Charles Nguyen, Irvine, CA (US)

(73) Assignee: NN Medical, Inc., Irvine, CA (US)

(21) Appl. No.: 15/911,155

(22) Filed: Mar. 4, 2018

(51) Int. Cl. G09B 7/02; G09B 5/02; G09B 5/12; H04L 29/06; G06F 17/30

(52) U.S. Cl. CPC G09B 7/02; G09B 5/02; G09B 5/12; G06F 17/30867; G06F 17/30858; G06F 17/3082; H04L 63/08

(57) ABSTRACT

An online teaching method, including the steps of: under control of a control center of an online teaching system, identifying authentication and associating account with a student in response to a request of accessing to an online platform of the online teaching system from the student; providing teaching videos in stages which are cut into segments for the student; providing feedback information interacting between the student and a plurality of teachers; grading the student by analyzing the teaching videos that the student recorded; and determining the graduation of the student by the judgement of the student teaching others.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION FIELD OF INVENTION

The present invention relates to the field of education, and more particularly to an online teaching system and method thereof.

### DESCRIPTION OF RELATED ARTS

Education is vitally important to human beings. Besides, the development of education is changed with the development of the human history especially with the great development of industrial production. Nowadays, education based on the information technology becomes common for learners such as students.

Behavioral therapy (BT) is based on the concept of sponsor system of A.A. (Alcoholics Anonymous) to engage students in active learning. An alcoholic has very low chance to quit alcohol by himself or herself. By joining A.A, an alcoholic has a little better chance to become sober because of an assigned sponsor, who guides him or her. By joining A.A, an alcoholic has a little better chance to become sober because of an assigned sponsor, who guides him or her. After 30-60 days of being sober, an alcoholic become a sponsor, whose job is to sponsor a newcomer.

By being a sponsor, an alcoholic would be accountable for his or her action. In order to set an example for his or her newcomer later, he or she will conscientious be off the sauce. As a result, the chance of being successful is much higher.

Similarly, a student has little chance to learn any new by himself or herself. By enrolling in class, a student has a little better chance to learn something new because of the teacher, who teaches him or her. The chance that students will learn well depends on their motivation and teacher's teaching technique.

On the other hand, cognitive behavioral therapy (CBT) is helpful for dealing with depression. As we all known, automatic thought of negative thoughts that cause people being depressed. The more negative thoughts, the more depressed people will be. Therefore, changing thinking and challenging the automatic thought of negative thoughts are vital for the depression.

Similarly, for a learner such as a student, unmotivated learning because of negative thoughts affects learning efficiency. For example, during learning process, the learner may have the negative thoughts of learning is too hard, too boring, etc. The more negative thoughts, the lower learning efficiency. Even worse, once the vicious circle is formed, the learner has less chance to learn well.

In a traditional online system, reading or listening to lectures about materials about safety, techniques or information that are important for students to know for the state board exam; and watching long, boring lectures of teacher talking or showing techniques. Besides, for a learner such as a student, reading is boring and not fun for majority of students, too much reading materials decreases learning interests. The traditional teaching in the classroom scenario causes that students have higher chance of being disengaged in learning.

### SUMMARY OF THE PRESENT INVENTION

The invention is advantageous in that it provides an online teaching system and method thereof, which is able to engage students in active learning.

Another advantage of the invention is to provide an online teaching system and method thereof, which minimizes reading materials, minimizes traditional teaching in the classroom scenario, maximizes simple video interaction, maximizes practical feedback, and provides simple video interactions.

Another advantage of the invention is to provide an online teaching system and method thereof, which engages students' attention and interest and provides a well feedback platform in learning, challenges students' learning behavior.

Another advantage of the invention is to provide an online teaching system and method thereof, which is able to increase profit and save costs.

Another advantage of the invention is to provide an online teaching system and method thereof, which is able to ensure top proficient quality result, which means that students once pass a class, they should be well trained.

Another advantage of the invention is to provide an online teaching system and method thereof, which is a revolutionized innovative ways to teach and to integrate both information technology and psychology aspects of cognitive behavioral therapy and behavioral therapy.

Another advantage of the invention is to provide an online teaching system and method thereof, which is able to solve the problem of lacking of qualified teachers and uniform teaching methods.

Additional advantages and features of the invention will become apparent from the description which follows, and may be realized by means of the instrumentalities and combinations particular point out in the appended claims.

According to the present invention, the foregoing and other objects and advantages are attained by an online teaching method, comprising the steps of:

under control of a control center of an online teaching system,

identifying authentication and associating account with a student in response to a request of accessing to an online platform of the online teaching system from the student;

providing teaching videos in stages which are cut into segments for the student;

providing feedback information interacting between the student and a plurality of teachers;

grading the student by analyzing the teaching videos that the student recorded; and

determining the graduation of the student by the judgement of the student teaching others.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of an online teaching system according to an embodiment of the present invention.

FIG. 2 is a web page of an online platform of the online teaching system according to the embodiment of the present invention.

FIG. 3 is a flow diagram of an online teaching method according to an embodiment of the present invention.

FIG. 4 is a flow diagram of the online teaching method according to the embodiment of the present invention.

FIG. 5 is a flow diagram of the online teaching method according to the embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

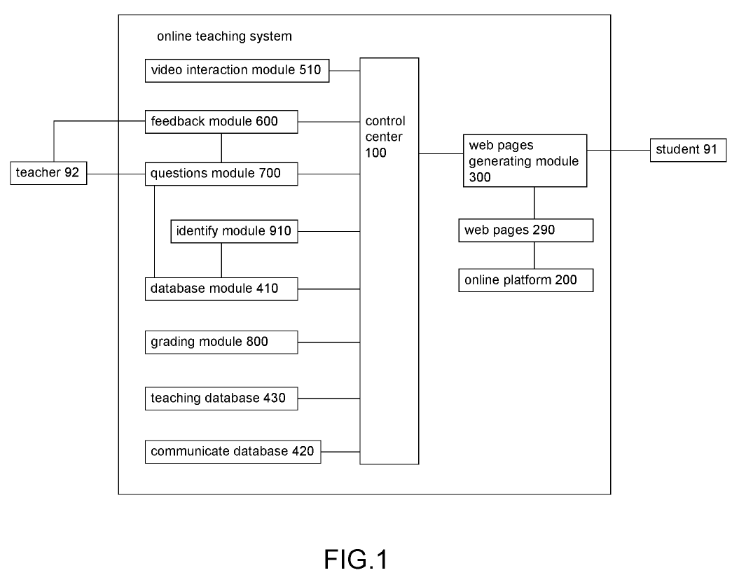

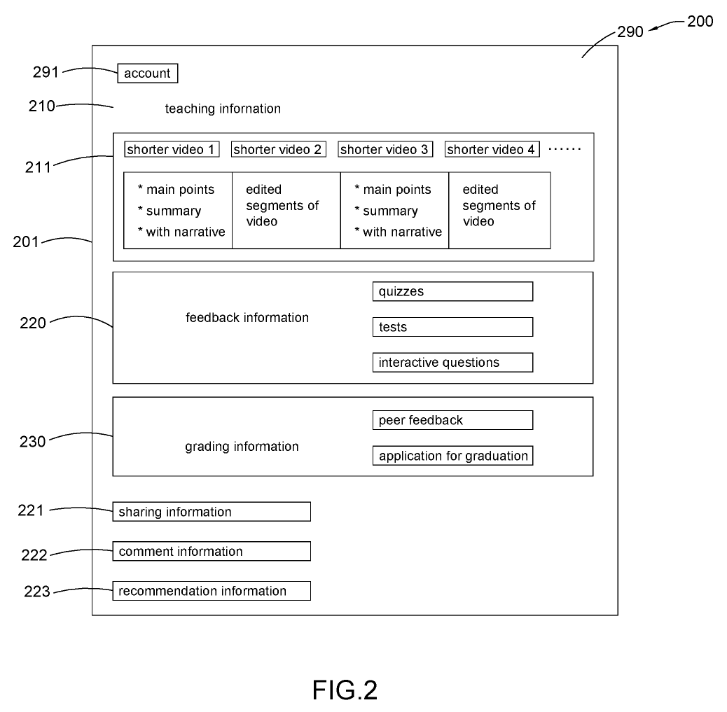

Referring to FIG. 1 and FIG. 2 of the drawings, an online teaching system according to a preferred embodiment of the present invention is illustrated. The online teaching system integrates both information technology and psychology aspects of cognitive behavioral therapy and behavioral therapy.

As shown in FIG. 1 of the drawings, the online teaching system comprises a control center 100 and an online platform 200. Different users such as students have access to the online platform 200 for learning through Internet. The control center 100 controls the online platform 200 so as to interact with the student 91. The control center 100 provides teaching information data and processes feedback information data, communicating information data and other information data from the online platform 200. The online platform 200 is based on the information technology. The student 91 is also able to learn knowledge and to interact with a teacher 92 via the online platform 200. In response to the requests of the student 91, the control center 100 receives the requests from the online platform 200 and processes the requests. The online teaching system further comprises a web pages generating module 300. The web pages generating module 300 generates a plurality of Web pages 201 with responding information and sends to the online platform 200 under the control of the control center 100. The plurality of Web pages 201 with responding information is displayed to the student 91 on the online platform 200. In other words, the Web pages 201 provides interactive interfaces to the student for online learning. The student 91 is able to access to the online platform 200 on computers, notebooks, iPad, mobile phones and other electrical devices through Internet. The student 91 is able to use the online platform 200 to learn and to communicate at any time and at any places they want.

Furthermore, the online teaching system further comprises a database module 410 and an identify module 910. The database module 410 is stored with student identity and account information. Under control of the control center 100, the identify module 910 identifies students and matches account for logging in and logging out.

More specifically, as shown in FIG. 2 of the drawings, a specific Web page 290 as an example generated by the web pages generating module 300 is illustrated. The student 91 uses his or her own account to log in the online platform 200 for learning. In response to the logging in request of the student 91, the identify module 910 of the online teaching system identifies authentication and associate account with the student 91 according to the student identity and account information stored in the database module 410. After identifying, a web page section 291 indicating identity of the student 91 is displayed on the online platform 200.

In a further, in response to a learning request of the student 91, the control center 100 acquires teaching information data from the teaching database module 430; the web pages generating module 300 generates the Web pages 201 with teaching information under control of the control center 100 and displays teaching information on the web page section 210 indicating the teaching information for students learning, so that the student 91 is able to learn on the online platform 200.

The online platform 200 also serves as communication platform for sharing experiences, posting comments, recommendation and so on. During students learning process, they are able to express their thoughts. The control center 100 receives the mentioned information data and responds to the students.

Students can share experiences, post comments and recommendation. When the student posts sharing experience information through a web page section 221 indicating sharing information, the control center 100 receives and stores the sharing information in the communicate database 420; the web pages generating module 300 retrieves and displays the sharing information from different students on the web page section 221, so that students are able to post and view the shared experience information on the web page section 221. Similarly, when the student posts comment information through a web page section 222 indicating his or her own comment information, the control center 100 receives and stores the comment information in the communicate database 420; the web pages generating module 300 retrieves and displays the comment information from different students on the web page section 222, so that students are able to post and view the comment information on the web page section 222. Similarly, when the student posts recommendation through a web page section 223 indicating his or her own recommendation, the control center 100 receives and stores the recommendation in the communicate database 420; the web pages generating module 300 retrieves and displays the recommendation from different students on the web page section 223, so that students are able to post and view the recommendation on the web page section 223.

The online teaching system further comprises a video interaction module 510 providing short and simple video interaction with learning information. The video interaction with learning information are retrieved by the web pages generating module 300 under control of the control center 100 and displayed on the web pages 290 such as a web page section 211 indicating the video interaction information on the online platform 200. For example, the online teaching system teaches the students how to perform quick express 20 minutes facial treatment or hair cutting.

It is worth mentioning that the overall teaching videos are cut into many parts and is provided to the students in stages. For example, each of the segments of the videos is no longer than 10 minutes. For theory, the edited segments of video could be animated, short segments of interviews, brief inspiration, lectures, etc. . . . . For example, when the students learn how to perform quick express 20 minutes facial treatment through the online platform 200, the overall 20 minutes teaching videos are cut into 4 segments with 5 minutes and are provided in stages by the video interaction module 510 under control of the control center 100. As a result, the cut segments of teaching videos are displayed on the web page section 211 by the web pages generating module 300. It is worth mentioning that before each of the edited segments of video, a preview section about the later segments of video such as the main points, summary, with narrative are provided before each the corresponding segments of video.

The online system also provides a feedback function to motive the student to learn and to engage students' attention, thereby challenging students' learning behavior and learning well. The online system further comprises a feedback module 600 controlled by the control center 100 and is interacted with the teacher 91 and the student 91.

Specifically, the feedback module 600 provides feedback questions and interaction interacting with the teacher 91 and the student 91 so as to make sure students understand. The teacher 91 and the student 91 are able to be interacted on the web page section 220 through the online platform 200. It is worth mentioning that the feedback could be in the form of sample test practice so that students can easily pass the exams. It is worth mentioning that the feedback can also be in the forms of quizzes, tests, and interactive questions.

Specifically, the feedback information are interacted between the teacher 91 and the student 91 by the feedback module 600 under control of the control center 100. The feedback information are in the forms of quizzes, tests and interactive questions. For example, the quizzes are the questions about the videos to make sure students understand and learn. Moreover, the quizzes are also be able to be linked to other videos teaching them the same concepts but they are presented in different way under control of the control center 100.

For example, the tests are practice test questions to help student passing exams. The interactive questions can improve the communication between the teacher and the students. The interactive questions can also improve the communication between students. As a result, students can learn better and quicker.

More specifically, the interactive questions of the feedback information can be implemented as common questions with pre-written answers stored in the database and answers from the teacher in real time and eventually sorted and stored in the database.

The online teaching system further comprises a questions module 700 processing the interactive questions of the feedback information under control of the control center 100. The processed interactive questions of the questions module 700 are displayed on the web pages 290 of the online platform 200 for the teachers and the students. For example, the common questions with pre-written answers stored in the database are displayed on the web page section 220, the student 91 can click on the displayed common questions, the questions module 700 acquires the corresponding answers from the database module 410 and provides to the web pages generating module 300 under control of the control center 100, so that the answer is displayed on the web pages 290 of the online platform 200 and provided to the student 91, thereby the online teaching system automatically providing answers of common questions to the students. It is worth mentioning that the answers can also be linked to the videos stored in the video interaction module 510 under control of the control center 100 or other related further reading material, so that the students can obtain more effective learning ways and more effective leaning efforts.

The web pages 290 of the online platform 200 also provides typing sections for students typing in his or her own learning questions. When the student 91 types in his or her own questions which are not the displayed common questions on online platform 200, the control center 100 processes the questions from the student 91 and responds to the teacher 92. The questions module 700 searches the best pre-written answers from the database module 410 in response to a searching request from the teacher 92 or obtains the answers from the teacher 92 if the questions module 700 cannot search the best pre-written answers from the database module 410. The answers which are searched or obtained by the questions module 700 are responded back to the online platform 200 under control of the control center 100 and are provided to the student 91. It is worth mentioning that if the questions module 700 cannot search the best pre-written answers from the database module 410, the answers sent from the teacher 92 will eventually sorted and stored in the database module 410, so that when the student 91 requires the answers of the similar questions, the answers can quickly and directly retrieved from the database module 410 by the questions module 700 and can be quickly responded and provided to the student 91.

After a period of learning, based on a concept of seeing one, doing one and teaching one, if the students want to be graduated, they must become a teacher to teach new students. In other words, similar to the theory of CBT and BT, every student have to become proficient teacher or trainer if they want to be graduated instead of passing exams or writing papers of the traditional teaching system. For example, if a student want to apply for graduation after learning through the online teaching system, he or she has to teach or train 3 other students. The number of being taught students can be changed to 1, 2, 3 or more. For example, the applicant records one training video for final grading. It is worth mentioning that the online teaching system is given prize for the best video to the student who records the training videos. The student is not only able to be graduated and is given the prize of the training video, but also other students can learn through the training video. It is worth mentioning that the best video for teaching is also provided on the online platform 200 for other students learning.

The online teaching system also provides peer feedback. The students can be graded to junior students and senior students. The senior students can also be graded to teachers. For example, the junior students can rank to senior students or teacher and vice versa. If the senior students do not do a good job, they can't graduate. Similarly, the senior students can “grade” and rank the junior students with specific recommendation.

It is worth mentioning that the good video and teaching materials from the senior students can be rewarded with scholarship or being recognized. For example, their videos can be used for that month.

More specifically, the online teaching system further comprises a grading module 800 for grading the students under control of the control center 100 so as to provide the peer feedback and the application for graduation. When a junior student want to be graded to a senior student, he or she applies through the web page section 230 of the online platform 200, the control center 100 receives the grading request from the junior student and controls the grading module 800 to search the teaching database 430, the grading module 800 responds the searching result to the control center 100 and the teacher 91, according to the grading and the judgment of the teacher 91, the grading result is responded to the junior student through the online platform 200. It is worth mentioning that if the grading result of the junior student is fitting for the condition of being a senior student, the identify module 910 will associate the senior grading result with the account of the junior student and refreshes the database module 410 under control of the control center 100. Therefore, the junior applicant is graded to a senior student through the online teaching system.

It is worth mentioning that the teaching video with teaching other students of the senior student will graded by the teachers and stored in the teaching database 430 in real time and for the graduation references of the senior students. Similarly, when a senior student want to be graduated, he or she applies through the web page section 230 of the online platform 200, the control center 100 receives the graduating request from the senior student and controls the grading module 800 to search the teaching database 430, the grading module 800 responds the searching result to the control center 100 and the teacher 91, according to the grading and the judgment of the teacher 91, the graduating result is responded to the senior student through the online platform 200. It is worth mentioning that if the graduating result of the junior student is fitting for the condition of being graduated, the identify module 910 will associate the graduating result with the account of the senior student and refreshes the database module 410 under control of the control center 100. Therefore, the senior applicant is graded to be graduated through the online teaching system.

It is worth mentioning that the online teaching system is based on a method of student's active outputting learning. The test for graduation of a skill is not test but is the successful teaching of three of the others. Moreover, compared with the traditional teaching method of one teacher corresponding to multiple students, the online teaching system of the present invention provides a method of one student corresponding to multiple teachers through the IT. Furthermore, based on the online teaching system, the performance test is provided and the students can grade the teachers. Subjects to be taught are those skills that someone can be the basic students who are simply learn to help themselves.

It is worth mentioning that student's tuition fee will only go to the best grades teachers. Moreover, even when the students grading the teachers are process of teaching. During the process of teaching, the teachers give suggestions to the test items to improve the test videos and subjects and items.

Through the online teaching system, students are able to learn more active and learn quickly, the online teaching system of the present invention minimizes reading materials, minimizes traditional teaching in the classroom scenario, maximizes simple video interaction, maximizes practical feedback, and provides simple video interactions. The innovative IT platform engages students' attention and interest, provides a well feedback platform in learning, challenges students' learning behavior, therefore, students who learn through the online teaching system are able to learn well than through the traditional teaching ways.

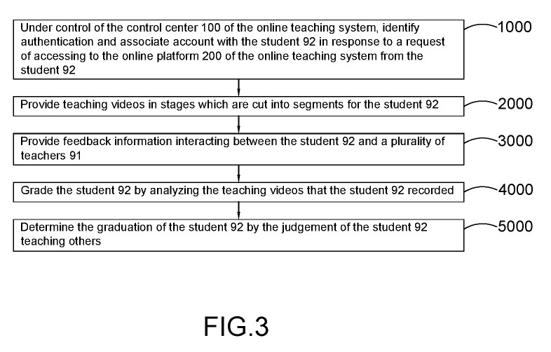

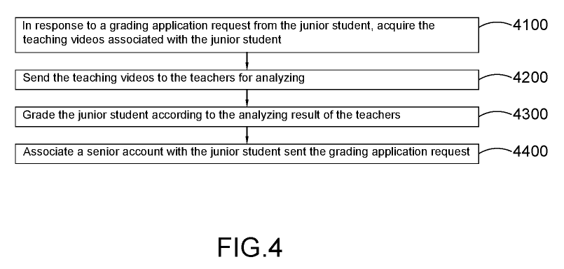

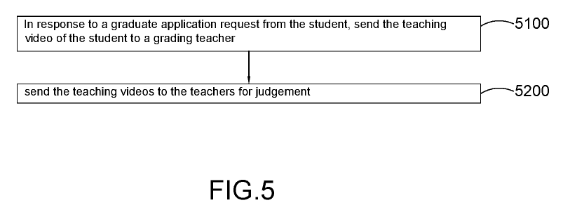

Referring to FIG. 3 to FIG. 5 of the drawings, an online teaching method according to an embodiment of the present invention is illustrated. The online teaching method comprises the following steps.

(1000) Under control of the control center 100 of the online teaching system, identify authentication and associate account with the student 92 in response to a request of accessing to the online platform 200 of the online teaching system from the student 92;

(2000) provide teaching videos in stages which are cut into segments for the student 92;

(3000) provide feedback information interacting between the student 92 and a plurality of teachers 91;

(4000) grade the student 92 by analyzing the teaching videos that the student 92 recorded; and

(5000) determine the graduation of the student 92 by the judgement of the student 92 teaching others.

In a further, the online teaching method comprises the following steps.

(2100) Provide a preview section about the later segment of video before each of the edited segments of teaching videos.

In a further, the online teaching method comprises the following steps.

(3100) Automatically provide answers to the students in response to a common question sent from the student;

(3200) link teaching videos related to the questions in the database and provide the related teaching videos to the student;

(3300) obtain a typed question from the student and search the answer of the typed question in the database;

(3400) if the answer of the typed question is stored in the database, provide the answer to the student;

(3500) if the answer of the typed question is not stored in the database, send the typed question to the plurality of teachers;

(3600) obtain the answer of the typed question from the plurality of teachers and provide the answer to the student; and

(3700) store the answer of the typed question from the plurality of teachers in the database.

In a further, the online teaching method comprises the following steps.

(6000) The student 92 records teaching videos of teaching others and the recorded teaching videos are sent and stored in the database of the online teaching system.

In a further, the online teaching method comprises the following steps.

(4100) In response to a grading application request from the junior student, acquire the teaching videos associated with the junior student;

(4200) send the teaching videos to the teachers for analyzing;

(4300) grade the junior student according to the analyzing result of the teachers; and

(4400) associate a senior account with the junior student sent the grading application request.

In a further, the online teaching method comprises the following steps.

(4110) Retrieve teaching video information of the student from the teaching database so as to acquire the teaching videos associated with the junior student.

In a further, the online teaching method comprises the following steps.

(4120) Send a teaching video recording request to the junior student and receive the teaching videos that the junior student recorded.

Based on the online teaching system, every student have to become proficient teacher or trainer in order to pass and to graduate. In a further, the online teaching method comprises the following steps.

(5100) In response to a graduate application request from the student, send the teaching video of the student to a grading teacher; and

(5200) send the teaching videos to the teachers for judgement.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An online teaching method, under control of a control center of an online teaching system, comprising the steps of:
identifying authentication and associating account with a student in response to a request of accessing to an online platform of the online teaching system from the student;
providing teaching videos in stages which are cut into segments for the student;
providing feedback information interacting between the student and a plurality of teachers;
grading the student by analyzing the teaching videos that the student recorded; and
determining the graduation of the student by the judgement of the student teaching others.

2. The online teaching method, as recited in claim 1, further comprising a step of:
providing a preview section about the later segment of video before each of the edited segments of teaching videos.

3. The online teaching method, as recited in claim 1, further comprising a step of:
automatically providing answers to the student in response to a common question sent from the student.

4. The online teaching method, as recited in claim 1, further comprising a step of:
linking teaching videos related to the questions in the database and providing the related teaching videos to the student.

5. The online teaching method, as recited in claim 1, further comprising a step of:
obtaining a typed question from the student and search the answer of the typed question in the database.

6. The online teaching method, as recited in claim 5, further comprising a step of:
providing the answer of the typed question to the student if the answer of the typed question is stored in the database.

7. The online teaching method, as recited in claim 5, further comprising a step of:
sending the typed question to the plurality of teachers if the answer of the typed question is not stored in the database.

8. The online teaching method, as recited in claim 7, further comprising a step of:
obtaining the answer of the typed question from the plurality of teachers and responding the answer of the typed question to the student.

9. The online teaching method, as recited in claim 8, further comprising a step of:
storing the answer of the typed question from the plurality of teachers in the database.

10. The online teaching method, as recited in claim 1, further comprising a step of:
the student recording teaching videos of teaching others and the recorded teaching videos are sent and stored in the database of the online teaching system.

11. The online teaching method, as recited in claim 1, further comprising steps of:
in response to a grading application request from the junior student, acquiring the teaching videos associated with the junior student;
sending the teaching videos to the teachers for analyzing; and
grading the junior student according to the analyzing result of the teachers.

12. The online teaching method, as recited in claim 11, further comprising a step of:
associating a senior account with the junior student sent the grading application request.

13. The online teaching method, as recited in claim 11, further comprising a step of:
retrieving teaching video information of the student from the teaching database so as to acquire the teaching videos associated with the junior student.

14. The online teaching method, as recited in claim 11, further comprising a step of:
sending a teaching video recording request to the junior student and receiving the teaching videos that the junior student recorded.

15. The online teaching method, as recited in claim 11, further comprising a step of:
the student recording teaching videos of teaching others and the recorded teaching videos are sent and stored in the database of the online teaching system.

16. The online teaching method, as recited in claim 1, further comprising the steps of:
in response to a graduate application request from the student as an applicant, acquiring the teaching videos of teaching others associated with the applicant; and
sending the teaching videos to the teachers for judgement so as to determine the graduation of the applicant.

17. The online teaching method, as recited in claim 16, further comprising a step of:
associating a graduated account with the student sent the graduate application request.

18. The online teaching method, as recited in claim 16, further comprising a step of:
retrieving teaching video information of the applicant from the teaching database so as to acquire the teaching videos associated with the applicant.

19. The online teaching method, as recited in claim 16, further comprising a step of:
sending a teaching video recording request to the applicant and receiving the teaching videos of teaching others that the applicant recorded.

20. The online teaching method, as recited in claim 16, further comprising a step of:
recording teaching videos of teaching others by the student and sending the recorded teaching videos to store in the database of the online teaching system.
